(19) United States
(12) Patent Application Publication
(10) Pub. No.: US 2023/0380565 A1
(43) Pub. Date: Nov. 30, 2023

(54) HAIRCARE APPLIANCE

(71) Applicant: Dyson Technology Limited, Wiltshire (GB)

(72) Inventors: David Andrew TIBBETTS, Bristol (GB); Maurizio BALLARATI, Swindon (GB)

(73) Assignee: Dyson Technology Limited, Wiltshire (GB)

(21) Appl. No.: 18/028,264

(22) PCT Filed: Sep. 28, 2021
(86) PCT No.: PCT/GB2021/052515

§ 371 Date: Mar. 24, 2023

(30) Foreign Application Priority Data
Sep. 30, 2020 (GB) 2015484.5

(51) Int. Cl. A45D 2/36

(52) U.S. Cl. CPC A45D 2/367; A45D 6/20

(57) ABSTRACT

A haircare appliance is described that includes a blower for generating an airflow, a plurality of outlets through which the airflow is discharged in one of a clockwise direction and a counterclockwise direction, and an indicator. The indicator has a first visual state when the airflow is discharged in a clockwise direction and a second visual state when the airflow is discharged in a counterclockwise direction.

### FIELD OF THE INVENTION

The present invention relates to a haircare appliance.

### BACKGROUND OF THE INVENTION

A haircare appliance may comprise a barrel around which hair is wrapped to create curls. Air may be discharged from the barrel in order to encourage the hair to wrap around the barrel.

### SUMMARY OF THE INVENTION

The present invention provides a haircare appliance comprising a blower for generating an airflow, a plurality of outlets through which the airflow is discharged in one of a clockwise direction and a counterclockwise direction, and an indicator having a first visual state when the airflow is discharged in a clockwise direction and a second visual state when the airflow is discharged in a counterclockwise direction.

The haircare appliance may comprise a single attachment having a first configuration in which the airflow is discharged in a clockwise direction and a second configuration in which the airflow is discharged in a counterclockwise direction. Alternatively, the haircare appliance may comprise a first attachment in which the airflow is discharged in a clockwise direction and a second attachment in which the airflow is discharged in a counterclockwise direction. In both instances, the indictor provides a visual indication of the direction in which the airflow is discharged.

The haircare appliance may be used to curl hair, and the direction of the curl may be determined by the direction of the airflow. By providing an indicator that has different visual states (i.e. different visual appearances) for the different airflow directions, a user is able to quickly and reliably determine the direction in which curls will be formed.

The haircare appliance may comprise a member moveable between a first position and a second position. The airflow is then discharged in a clockwise direction when the member is in the first position, and in a counterclockwise direction when the member is in the second position. This then has the advantage that the direction of the airflow may be changed relatively quickly and conveniently. In particular, the direction of the airflow may be changed without the need to change attachments.

The outlets may comprise first outlets through which the airflow is discharged in a clockwise direction and second outlets through which the airflow is discharged in a counterclockwise direction. The member may then occlude the airflow to the second outlets when in the first position, and occlude the airflow to the first outlets when in the second position. This then provides a relatively robust mechanism for achieving both clockwise and counterclockwise airflow.

The haircare appliance may comprise a sensor for sensing the position of the member, and the indicator may have a visual state that depends on an output of the sensor. In particular, the sensor may generate an electrical signal that is then used to determine the visual state of the indicator. The sensor may comprise, by way of example, a mechanical sensor (e.g. a switch), an optical sensor, or a magnetic sensor.

The haircare appliance may comprise a switch, and the indicator may have the first visual state when the switch is one of open and closed, and the second visual state when the switch is the other of open and closed. Movement of the member between the first position and the second position may then cause the switch to change between open and closed. For example, the member may act upon and close the switch when the member is in one of the first position and the second position. By providing a switch which is either open or closed according to the position of the member, an electrical signal may be generated for use in determining the visual state of the indicator.

The haircare appliance may comprise a user-actuated selector for moving the member between the first position and the second position. As a result, the user is able to change the direction of the airflow by means of the selector.

The selector may comprise a dial that rotates in order to move the member between the first position and the second position. As a result, a user is able to select a particular airflow direction in an intuitive way by rotating the selector in either a clockwise or counterclockwise direction.

The selector may be provided at an end of the haircare appliance. This then has the advantage that inadvertent movement of the selector during use of the haircare appliance may be less likely. Additionally, where the airflow discharged from the outlets is hot (e.g. where the appliance comprises a heater for heating the airflow), the risk of a user contacting a hot part of the haircare appliance when moving the selector may be reduced.

When using the haircare appliance, a user may view the haircare appliance in a mirror. As a result, the image of the haircare appliance is inverted. Additionally, the haircare appliance may be used in any number of positions, from vertical upright to upside down. The indicator may generate static illumination in each of the visual states. However, owing to the various positions in which the haircare appliance may be used, as well as the inversion generated by the mirror, it may be difficult for a user to discern quickly the direction of the airflow, and thus in which direction to manipulate the haircare application. Accordingly, the indicator may generate moving illumination in each of the first visual state and the second visual state. Moreover, the movement may occur in a first direction in the first visual state, and in a second opposite direction in the second visual state. As a result of the moving illumination, a user may more quickly and/or more reliably discern the direction of the airflow, and thus the direction in which to manipulate the haircare appliance.

The indicator may comprise an array of LEDs. This then provides a cost-effective solution for providing a visual indication of the direction of the airflow.

The indicator may comprise a ring of LEDs, which are illuminated in a clockwise sequence in the first visual state and in a counterclockwise sequence in the second visual state. As a result, the indictor provides moving illumination that directly corresponds to the direction of the airflow.

The haircare appliance may comprise a handle unit and an attachment attached to the handle unit. The handle unit then comprises the blower and the indicator, and the attachment comprises the outlets. This arrangement then has the advantage that the indictor is less likely to be obscured by hair during use. By contrast, if the indicator were provided on the attachment, hair may wrap around the attachment and obscure the indicator.

The attachment may be removably attached to the handle unit. This then has the advantage that the handle unit may be used with other types of attachment, such as a styling brush or hair dryer nozzle. Moreover, by providing the indicator on the handle unit, the indicator may be used in conjunction with other attachments.

The attachment may comprise a transmitter for transmitting wirelessly data to the handle unit, the handle unit may comprise a receiver for receiving the data, and the indicator may have a visual state that depends on the data. This then has the advantage that the direction of the airflow may be determined at the handle unit without the need for electrical contacts or terminals between the handle unit and the attachment, which might otherwise present a safety concern, particularly as the haircare appliance may be used with wet hair. Conceivably, the handle unit may comprise a switch or other mechanical part which is closed or moved by the attachment according to the direction of the airflow. However, the haircare appliance may be used with haircare products, such as a hair spray, mousse or lotion. These haircare products, as well as dirt more generally, may coat electrical contacts or gum mechanical switches or other moving parts. By transmitting wirelessly data to the handle unit, a more reliable and robust mechanism may be achieved for communicating the direction of the airflow to the handle unit.

The attachment may comprise an RFID tag and the handle unit may comprise an RFID reader. The RFID reader may transmit an interrogation signal to the RFID tag, and the RFID tag may, in response, transmit data to the RFID reader. The indicator then has a visual state that depends on the data. This then provides a relatively cost-effective method of transmitting data wirelessly from the attachment to the handle unit. In particular, the RFID tag may be passive (i.e. unpowered) and the interrogation signal may be used to energies the RFID tag.

The RFID tag may comprise an antenna and an integrated circuit. The antenna may be provided at a first end of the attachment, and the integrated circuit may be provided at a second opposite end of the attachment. This then has the advantage that the antenna may be provided at the end of the attachment which attaches to the handle unit. As a result, a relatively short distance may be achieved between the antenna of the RFID tag and the antenna of the RFID reader, and thus the RFID tag may be energised at relatively low power. The integrated circuit, by contrast, may be provided at the opposite end of the attachment, and thus a relatively compact arrangement may be achieved. Additionally, improved thermal isolation may be achieved between the integrated circuit and the airflow, which may be hot.

The present invention also provides a handle unit of a haircare appliance, the handle unit being removably attachable to an attachment of the haircare appliance, wherein the handle unit comprises a blower for generating an airflow and an indicator, the attachment comprises a plurality of outlets through which the airflow is discharged in one of a clockwise direction and a counterclockwise direction, and the indicator has a first visual state when the airflow is discharged in a clockwise direction and a second visual state when the airflow is discharged in a counterclockwise direction.

The handle unit may comprise a receiver for receiving data from the attachment, and the indicator may have a visual state that depends on the data. For example, the handle unit may comprise an RFID reader and the attachment may comprise an RFID tag that transmits data indicative of the direction of airflow.

The present invention further provides an attachment of a haircare appliance, the attachment being removably attachable to a handle unit of the haircare appliance, wherein the attachment comprises an inlet for receiving an airflow from the handle unit, and a plurality of outlets through which the airflow is discharged in one of a clockwise direction and a counterclockwise direction, and the attachment provides an indication to the handle unit of the direction in which the airflow is discharged.

The attachment may comprise a member moveable between a first position and a second position. The airflow is then discharged in a clockwise direction when the member is in the first position, and in a counterclockwise direction when the member is in the second position. Moreover, the outlets may comprise first outlets through which the airflow is discharged in a clockwise direction and second outlets through which the airflow is discharged in a counterclockwise direction. The member may then occlude the airflow to the second outlets when in the first position, and occlude the airflow to the first outlets when in the second position.

The attachment may comprise a sensor for sensing the position of the member, and an output of the sensor may be provided to the handle unit.

The attachment may provide the indication wirelessly. For example, the attachment may comprise an RFID tag that transmits data indicative of the direction of airflow to the handle unit.

### BRIEF DESCRIPTION OF THE DRAWINGS

Embodiments will now be described, by way of example, with reference to the accompanying drawings in which:

FIG. 1 illustrates a haircare appliance;

FIG. 2 is a simplified section through a handle unit of the haircare appliance;

FIG. 3 is a block diagram of electrical components of the haircare appliance;

FIG. 4 is an exploded view of an attachment of the haircare appliance;

FIG. 5 is a side view of the attachment;

FIG. 6 is a vertical section through the attachment;

FIG. 7 are horizontal sections through the attachment in which the attachment is configured to discharge airflow in (a) a clockwise direction, or (b) a counterclockwise direction;

FIG. 8 illustrates a user changing the configuration of the attachment;

FIG. 9 is a perspective view of an alternative attachment;

FIG. 10 is an exploded view of the alternative attachment; and

FIG. 11 are horizontal sections through the alternative attachment in which the alternative attachment is configured to discharge airflow in (a) a clockwise direction, or (b) a counterclockwise direction.

### DETAILED DESCRIPTION OF THE INVENTION

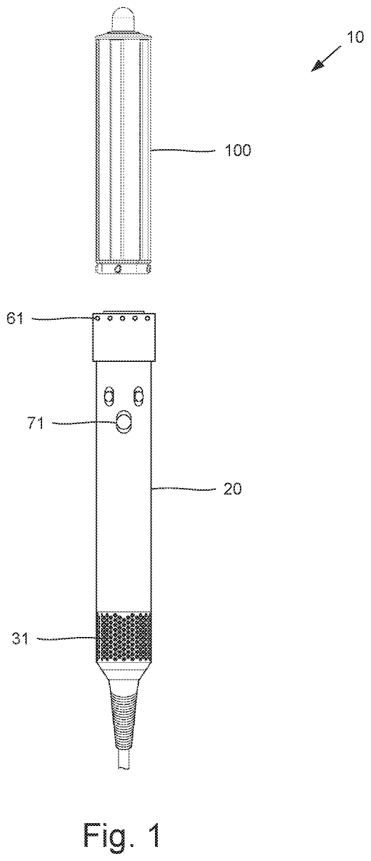

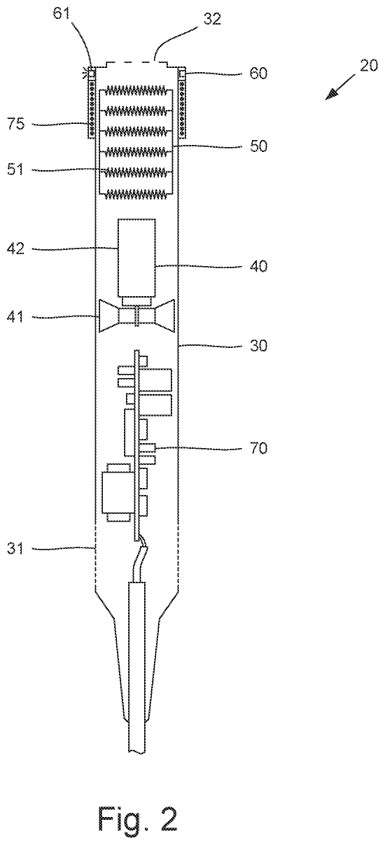

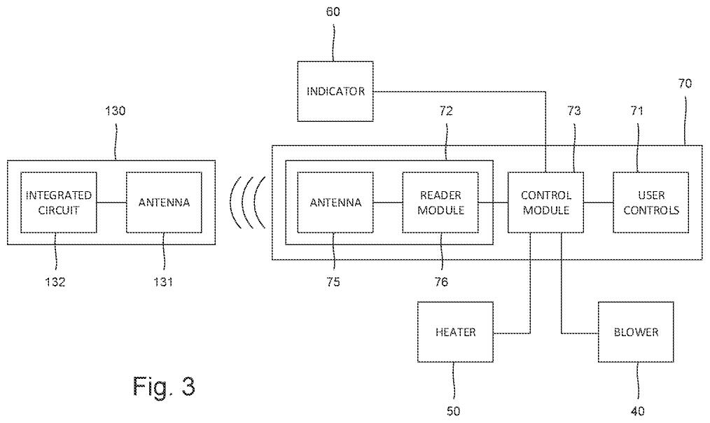

The haircare appliance 10 of FIGS. 1 to 3 comprises a handle unit 20 and an attachment 100 removably attachable to the handle unit 20.

The handle unit 20 comprises a housing 30, a blower 40, a heater 50, an indicator 60, and a control unit 70.

The housing 30 is tubular in shape and comprises an inlet 31 through which an airflow is drawn into the housing 30 by the blower 40, and an outlet 32 through which the airflow is discharged from the housing 30. The blower 40 is housed within the housing 30 and comprises a fan 41 driven by an electric motor 42. The heater 50 is also housed within the housing 30 and comprises heating elements 51 to optionally heat the airflow. The indicator 60 comprises an array of LEDs 61 arranged as a ring around the outside of the housing 30.

The control unit 70 comprises user controls 71, an RFID reader 72 and a control module 73.

The user controls 71 are provided on the surface of the housing 30 and are used to power on and off the haircare appliance 10, to select a flow rate (e.g. high, medium, low), and to select an air temperature (e.g. hot, warm, cold). In this example, each of the user controls 71 comprises a sliding switch. However, other forms of user control may be used such as buttons, dials or touchscreen.

The RFID reader 72 comprises an antenna 75 and a reader module 76. The RFID reader 72 interrogates an RFID tag 130 that forms part of the attachment 100. As described below, the attachment 100 discharges airflow in either a clockwise or counterclockwise direction, and the data returned by the RFID tag 130 is indicative of the direction of the airflow. The RFID reader 72 therefore outputs data to the control module 73 that indicates if the attachment 100 is attached to the handle unit 20 and, if attached, if the airflow discharged from the attachment 100 is moving in a clockwise or counterclockwise direction.

The control module 73 is responsible for controlling the blower 40, the heater 50 and the indicator 60 in response to inputs from the user controls 71 and the RFID reader 72. For example, in response to inputs from the user controls, the control module 73 may control the power or speed of the blower 40 in order to adjust the flow rate of the airflow, and the power of the heater 50 in order to adjust the temperature of the airflow.

The control module 73 controls the indicator 60 in response to an input from the RFID reader 72. As noted above, the RFID reader outputs data that is indicative of the direction of the airflow discharged from the attachment 100. The control module 73 uses this data to illuminate the LEDs of the indicator 60 in manner that reflects the direction of the airflow.

The indicator 60 has a plurality of visual states, with the LEDs 61 being illuminated differently in each visual state. More particularly, the indicator 60 has a first visual state in which the LEDs 61 are illuminated sequentially in a clockwise direction around the housing 30, and a second visual state in which the LEDs 61 are illuminated sequentially in a counterclockwise direction. The control module 73 controls the visual state of the indicator 60 according to the direction of the airflow discharged from the attachment 100, as indicated by the data received by the RFID reader 72. In particular, the indicator 60 has the first visual state when the airflow is discharged from the attachment in a clockwise direction, and the indicator 60 has the second visual state when the airflow is discharged in a counterclockwise direction. As a result, the indicator 60 provides a visual indication of the direction in which the airflow is discharged from the attachment 100.

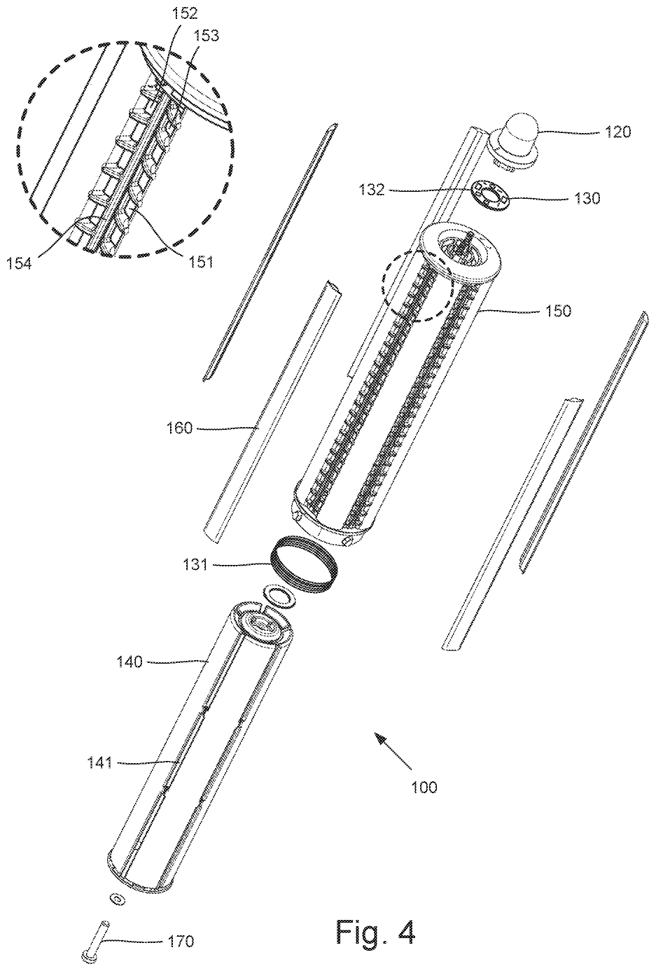

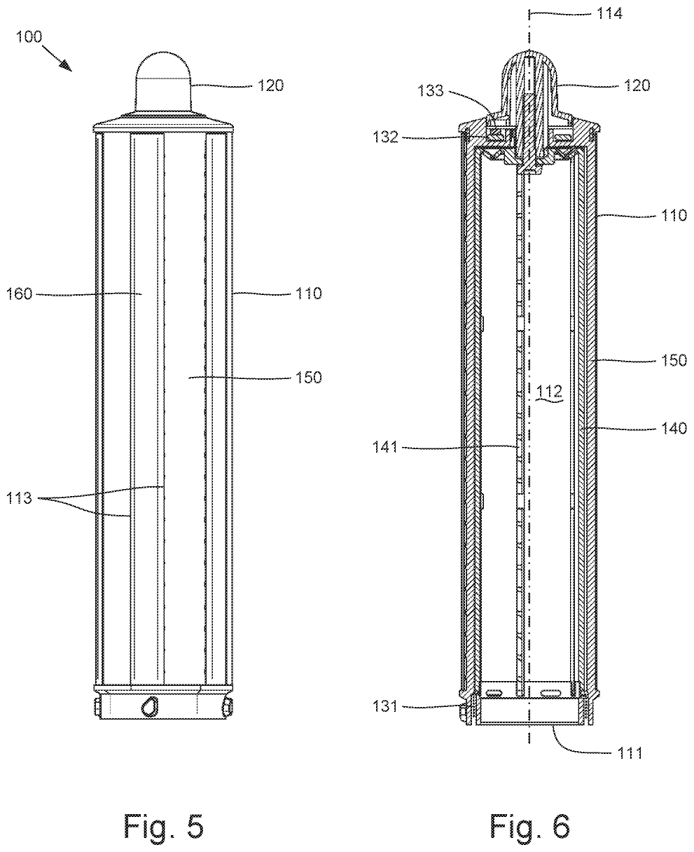

Referring now to FIGS. 4 to 8, the attachment 100 comprises a barrel 110, a dial 120, and an RFID tag 130.

The barrel 110 is cylindrical in shape, is open at one end and is closed at the other end. The open end serves as an inlet 111 to the interior 112 of the barrel 110. A plurality of outlets 113 are formed around the side the barrel. Each outlet 113 comprises a slot that extends along the length of the barrel 110, and the outlets 113 are spaced evenly around a longitudinal axis 114 of the barrel 110.

The barrel 110 comprises an inner sleeve 140, an outer sleeve 150, and a plurality of slats 160. The inner sleeve 140 and the outer sleeve 150 are each cylindrical in shape. The inner sleeve 140 sits within the outer sleeve 150 and comprises a plurality of slots 141 that extend along the length of the inner sleeve 140. In the particular example shown in the Figures, the inner sleeve 140 comprises five slots 141.

The outer sleeve 150 comprises a plurality of openings 151 arranged into columns that extend along the length of the outer sleeve 150. More particularly, the openings 151 are arranged into pairs of columns 152, 153 that are spaced evenly around the outer sleeve 150. Again, in the particular example shown in the Figures, the outer sleeve 150 comprises five pairs of columns 152, 153. Each pair of columns 152, 153 is separated by a spine 154.

Each of the slats 160 is attached to one of the spines 154 of the outer sleeve 150, e.g. by snap fit. Each slat 160 extends either side of the spine 154 and overlies each of the columns of openings 152, 153. The edges of the slat 160 are spaced radially from the outer sleeve 150 to create two slots 113a, 113b between the slat 160 and the outer sleeve 150 that extend along the length of the barrel 110. Each of the slots 113a, 113b defines an outlet 113 of the barrel 110.

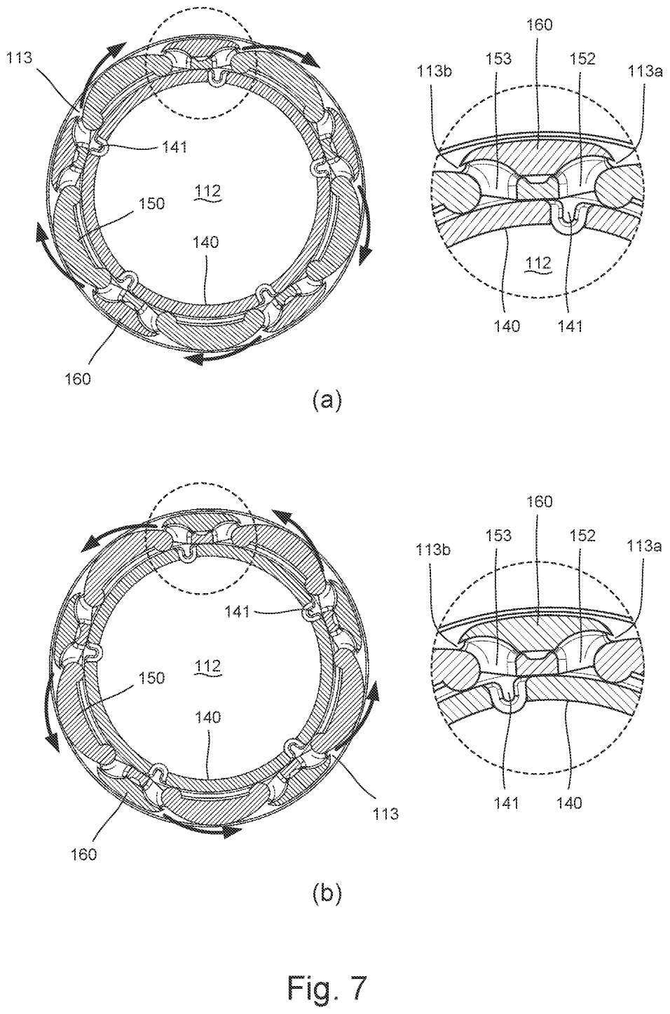

The inner sleeve 140 is moveable relative to the outer sleeve 150. More particularly, the inner sleeve 140 rotates relative to the outer sleeve 150 about the longitudinal axis 114 of the barrel 110. The inner sleeve 140 is moveable between a first position and a second position. In the first position, shown in FIG. 7(a), each of the slots 141 in the inner sleeve 140 is aligned with a first column of openings 152 in the outer sleeve 150. In the second position, shown in FIG. 7(b), each of the slots 141 in the inner sleeve 140 is aligned with a second column of openings 153 in the outer sleeve 150.

During use, when the attachment 100 is attached to the handle unit 20, the airflow generated by the handle unit 20 enters the interior 112 of the barrel 110 via the inlet 111. From there, the airflow moves radially outward through the slots 141 in the inner sleeve 140. The airflow then passes through the openings 151 in the outer sleeve 150. More particularly, the airflow passes through either the first columns of openings 152 or the second columns of openings 153 in the outer sleeve 150, according to the position of the inner sleeve 140. When the inner sleeve 140 is in the first position (FIG. 7(a)), the airflow passes through each first column of openings 152. The airflow is then turned by the slats 160 in a clockwise direction. As a result, the airflow is discharged from the barrel 110 in a clockwise direction. When the inner sleeve 140 is in the second position (FIG. 7(b)), the airflow passes through each second column of openings 153. The airflow is then turned by the slats 160 in a counterclockwise direction, and the airflow is discharged from the barrel 110 in a counterclockwise direction. Accordingly, by changing the position of the inner sleeve 140, the direction of the airflow discharged from the barrel 110 may be changed from clockwise to counterclockwise.

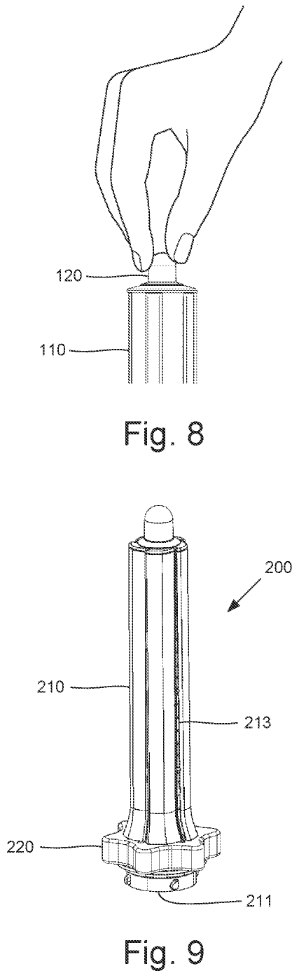

The dial 120 is provided at the top of the barrel 110 and is attached to the inner sleeve 140 (in this example, by means of a screw 170). The dial 120 may be used to move the inner sleeve 140 between the first and second positions. For example, as illustrated in FIG. 8, a user may grip and twist or rotate the dial 120 so as to move the inner sleeve between the two positions. As a result, a user is able to change the direction in which the airflow is discharged from the barrel 110. More particularly, a user is able to select whether the airflow is discharged in a clockwise or counterclockwise direction.

The RFID tag 130 comprises an antenna 131 and an integrated circuit 132. The antenna 131 is located towards the bottom of the barrel 110 within a recess in the outer sleeve 150. The integrated circuit 132, by contrast, is located towards the top of the barrel 110 between the outer sleeve 150 and the dial 120. The antenna 131 and the integrated circuit 132 are connected by conductive tracks (not shown) provided along the inner surface of the outer sleeve 150. The integrated circuit 132 comprises components typical of an RFID tag, such as a rectifier, microcontroller and load modulator. The integrated circuit 132 further comprises a switch 133, such as a surface-mounted momentary switch, that is activated by movement of the dial 120. When the dial 120 and thus the inner sleeve 140 are in one position (e.g. the first position), the switch 133 is open. When the dial 120 and the inner sleeve 140 are moved to the other position (e.g. the second position), the dial 120 acts upon the switch 133 (e.g. depresses the switch), causing the switch 133 to close.

The RFID tag 130 is energised by an interrogation signal transmitted by the RFID reader 72. Upon energization, the RFID tag 130 transmits data to the RFID reader 72. The data returned by the RFID tag 130 depends on the state of the switch 133. In particular, the RFID tag 130 returns first data when the switch 133 is open and second data when the switch 133 is closed. The RFID tag 130 therefore transmits data that is indicative of the direction of the airflow discharged from the barrel 110.

With the haircare appliance 10 described above, the indictor 60 provides a visual indication of the direction in which the airflow is discharged. The haircare appliance 10 may be used to curl hair, and the direction of the curl may be determined by the direction of the airflow. By providing an indicator 60 that has different visual states for the different airflow directions, a user is able to quickly and reliably determine the direction in which curls will be formed.

The direction of the airflow may be changed using the dial 120 at the top of the attachment 100. This then provides a relatively quick and convenient way to change the direction of the airflow. Changes in the direction of the airflow are brought about by the movement of the inner sleeve 140 relative to the outer sleeve 150. However, changes in the direction of the airflow may be brought about by other means. By way of example, FIGS. 9 to 11 show an alternative attachment that comprises alternative features for achieving changes in the direction of the airflow.

The attachment 200 of FIGS. 9 to 11, like that of FIGS. 4 to 7, comprises a barrel 210, a dial 220, and an RFID tag 230.

The barrel 210 is again generally cylindrical in shape, is open at one end and is closed at the other end. The open end serves as an inlet 211 to the interior 212 of the barrel 210, and a plurality of outlets 213 are formed along the side the barrel 210. Each outlet 213 comprises a slot, and the outlets 213 are spaced evenly around the longitudinal axis of the barrel 210.

The barrel 210 comprises an inner sleeve 240, a plurality of louvres 250, and a knob 260.

The inner sleeve 240 is generally cylindrical in shape, is open at a bottom end and closed at a top end. A plurality of slots 241 extend along the length of the sleeve 240. The slots 241 are relatively wide and thus the inner sleeve 240 may be regarded as having columns 242 that extend upwards from the bottom to the top of the sleeve 240. In the particular example shown in the Figures, the inner sleeve comprises five slots 241 and five columns 242.

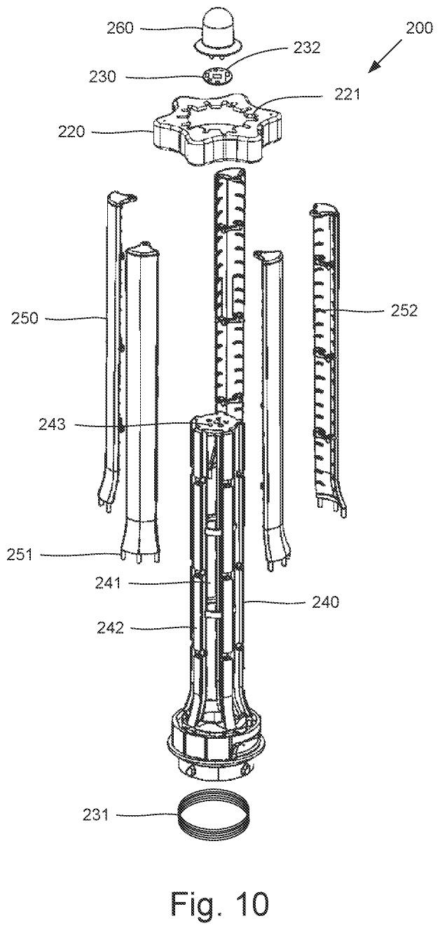

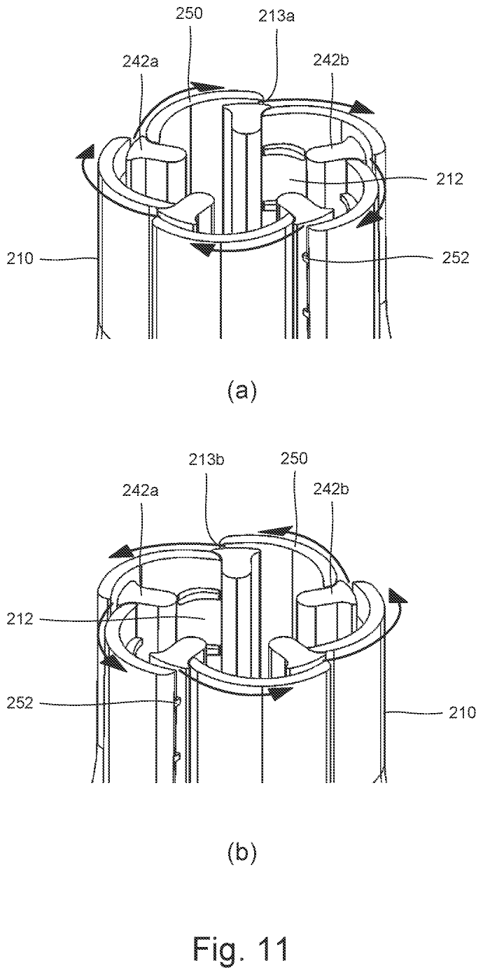

Each of the louvres 250 covers a respective slot 241 in the inner sleeve 240. A top end of each louvre 250 is pivotally attached to the top of the inner sleeve 240. A bottom end of each louvre comprises pins or legs 251 that are received within slots 221 in the dial 220. Each of the louvres 250 pivots between a first position and a second position. The pivot point of each louvre 250 is offset from the longitudinal axis 214 of the barrel 210. This is perhaps best appreciated in FIG. 10, in which it can be seen that each louvre 250 is pivotally connected to the inner sleeve 240 at positions 243 that are offset from the centre. Consequently, when in the first position, as shown in FIG. 11(a), each louvre 250 contacts a first column 242a of the sleeve 240 along a first edge of the louvre 250. A gap or slot 213a is then created between the louvre 250 and the inner sleeve 240 along a second edge of the louvre 250. When in the second position, as shown in FIG. 11(b), each louvre 250 contacts a second column 242b of the sleeve 240 along the second edge of the louvre 250, and a gap or slot 213b is created between the louvre 250 and the inner sleeve 240 along the first edge. Each of the slots 213a, 213b defines an outlet 213 of the barrel 210. As can be seen in FIG. 11, when the louvres 250 are in the first position (FIG. 11(a)), the airflow is discharged from the barrel 210 in a clockwise direction and when the louvres 250 are in the second position (FIG. 11(b)), the airflow is discharged in a counterclockwise direction.

Each of the louvres 250 comprises vanes 252 that extend circumferentially around the inner surface of the louvre 250. As the airflow moves from the inlet 211 of the barrel 210 to each of the outlets 213, the vanes 252 turn the airflow from a generally vertical direction (i.e. parallel to the longitudinal axis of the barrel) to a generally horizontal direction (i.e. normal to the longitudinal axis of the barrel). As a result, the airflow is discharged from the outlets 213 in a generally circumferential direction, which better encourages the airflow to wrap around the barrel 210.

The dial 220 resembles a star-shaped wheel that surrounds the bottom of the inner sleeve 240. The dial 220 comprises slots 221 into which the legs 251 of the louvres 250 are received. The dial 220 is rotatable relative to the inner sleeve 240. More particularly, the dial 220 is rotatable about the longitudinal axis of the barrel 210. Rotating the dial 220 clockwise and counterclockwise causes each of the louvres 250 to pivot between the first position and the second position. Consequently, the dial 220 may be used to change the direction in which the airflow is discharged from the barrel 210.

The knob 260 is attached to the top of the inner sleeve 240 and is isolated from the airflow moving within the barrel 210. The knob 260 therefore provides a relatively cool area of the barrel 210 which a user may grip when manipulating the haircare appliance 10.

The RIF tag 230 is unchanged from that described above in connection with FIGS. 4 to 7. In particular, the RFID tag 230 comprises an antenna 231 located at the bottom of the barrel 210, and an integrated circuit 232 located at the top of the barrel 210. More particularly, the integrated circuit 232 is located between the inner sleeve 240 and the knob 260, and comprises a switch (not shown) that is closed by one of the louvres 250 when moving between the first position and the second position. The RFID tag 230 therefore transmits data to the handle unit 20 that is indicative of the direction of the airflow.

The attachments 100, 200 described above change the direction of the airflow in different ways. However, common to each is the presence of a member(s) (e.g. the inner sleeve 140 of FIGS. 4 to 7 or the louvres 250 of FIGS. 9 to 11) that moves between a first position and a second position. The airflow is then discharged from the attachment in a clockwise direction when the member(s) is in the first position, and the airflow is discharged in a counterclockwise direction when the member(s) is in the second position. Moreover, each of the attachments 100, 200 may be said to have first outlets 113a, 213a through which the airflow is discharged in a clockwise direction and second outlets 113b, 213b through which the airflow is discharged in a counterclockwise direction. The member(s) 140, 250 then occludes the airflow to the second outlets 113b, 213b when in the first position, and occludes the airflow to the first outlets 113a, 213a when in the second position.

For example, with the attachment 100 of FIGS. 4 to 7, the barrel 110 may be said to have a first outlets 113a and second outlets 113b formed between the slats 160 and the outer sleeve 150. The airflow is discharged in a clockwise direction through the first outlets 113a (FIG. 7(a)) and in a counterclockwise direction through the second outlets 113b (FIG. 7(b)). The inner sleeve 140 (i.e. the member) is moveable from a first position in which the sleeve 140 occludes the path of the airflow to the second outlets 113b (FIG. 7(a)) to a second position in which the sleeve 140 occludes the path of the airflow to the first outlets 113a (FIG. 7(b)).

Each of the attachments 100, 200 comprises a switch that senses the position of the moveable member (e.g. inner sleeve or louvres), and thus the direction of the airflow. The switch may sense the position of the moveable member directly or indirectly. For example, the switch 133 of the first attachment 100 senses the position of the inner sleeve 140 indirectly via the dial 120, whilst the switch of the second attachment senses the position of the louvres directly. The position of the moveable member, and thus the direction of the airflow, may be sensed in other ways. For example, rather than a switch, the attachment may comprise an optical sensor or a magnetic sensor (such as a Hall-effect sensor), and the moveable member or the dial may comprise an optical marker(s) or a magnetic element which the sensor then senses.

Each of the attachments 100, 200 employs RFID in order to transmit data from the attachment to the handle unit 20. The data is defined by the output of the sensor and therefore provides an indication of the direction of airflow. Whilst the attachments described above employ RFID, other forms of wireless protocol, such as NFC or Bluetooth, might alternatively be used. That said, the provision of a passive RFID tag which is energised by the RFID reader provides a relatively cost-effective solution since the attachment is not required to have a battery or other energy source in order to transmit data.

The data need not be transferred wirelessly from the attachment 100, 200 to the handle unit 20. For example, the attachment and the handle unit may each comprise electrical contacts that are brought into contact when the attachment is attached to the handle unit. The output of the sensor may then be delivered directly to the control module. Moreover, the sensor need not be provided on the attachment and may instead be provided on the handle unit. By way of example only, the handle unit 20 may comprise a switch that is activated (e.g. depressed) by movement of the inner sleeve 140 of the attachment 100 of FIGS. 4 to 7. As a further example, the handle unit 20 may comprise an optical sensor and the dial 220 of the attachment 200 of FIGS. 9 to 11 may comprise a marker(s) on the underside of the dial 220. Accordingly, in a more general sense, the haircare appliance 10 may be said to comprise a sensor for sensing, either directly or indirectly, the position of the moveable member and thus the direction of the airflow, and that the sensor may be provided on the attachment or on the handle unit.

There are, nevertheless, advantages in locating the sensor on the attachment and transmitting data wirelessly from the attachment to the handle unit. For example, exposed electrical contacts between the handle unit and the attachment may present a safety concern, particularly as the haircare appliance may be used with wet hair. Additionally, haircare products, such as a hair spray, mousse or lotion, as well as dirt more generally, may coat and render ineffective the electrical contacts. Similarly, if the handle unit were to comprise the sensor, dirt, debris and/or haircare products may coat or gum the sensor. By transmitting data wirelessly to the handle unit, a more reliable and robust mechanism may be achieved for determining the direction of the airflow.

Each of the attachments described above comprises a dial for selecting clockwise or counterclockwise airflow. The provision of a dial, which rotates about the longitudinal axis of the barrel, provides the user with a relatively intuitive way for changing the direction of the airflow. In particular, the user may rotate the dial clockwise and counterclockwise in order to select respectively clockwise and counterclockwise airflow. In spite of the aforementioned advantages, the haircare appliance may comprise an alternative type of selector that may be actuated by a user in order to select clockwise or counterclockwise airflow.

Each of the attachments is removably attached to a handle unit. This then has the advantage that the handle unit may be used with other types of attachment, such as a styling brush or hair dryer nozzle. Nevertheless, the haircare appliance could conceivably comprise an attachment that is permanently attached to the handle unit.

The attachments described above are each capable of delivering both clockwise and counterclockwise airflow. This then has the advantage that clockwise and counterclockwise airflow may be achieved with a single attachment. Nevertheless, the haircare appliance could conceivably have a first attachment that delivers airflow in a clockwise direction, and a second attachment that delivers airflow in a counterclockwise direction. Irrespective of whether the haircare appliance comprises a single attachment or a pair of attachments, the indictor provides a visual indication of the direction in which the airflow is discharged. Where the haircare appliance comprises different attachments for clockwise and counterclockwise airflow, each attachment may comprise a unique identifier (e.g. RFID tag, optical marker, magnetic element or physical feature) which the handle unit senses in order to determine the direction of the airflow.

The indicator comprises a ring of LEDs and has a first visual state in which the LEDs are illuminated sequentially in a clockwise direction, and a second visual state in which the LEDs are illuminated sequentially in a counterclockwise direction. Conceivably, the indicator may comprise alternative means for indicating the direction of the airflow of the attachment, e.g. an alternative arrangement of LEDs or a display screen. The indicator nevertheless has a first visual state when the airflow is discharged in a clockwise direction and a second, different visual state when the airflow is discharged in a counterclockwise direction. The indicator may generate static illumination in each of the visual states. However, it has been observed that, where static illumination is used, a user may have greater difficulty in discerning quickly the direction of the airflow, and thus in which direction to manipulate the haircare application. This behaviour is thought to occur for a couple of reasons. First, when using the haircare appliance, a user is likely to view the haircare appliance in a mirror. As a result, the image of the haircare appliance is inverted. Additionally, the haircare appliance may be used in any number of positions, from vertical upright to upside down. Owing to the various positions in which the haircare appliance may be used, as well as the inversion generated by the mirror, it is believed that a user may have greater difficulty discerning the direction of the airflow based solely on static illumination. The indicator may therefore generate moving illumination in each of the first visual state and the second visual state. Moreover, the movement may occur in a first direction in the first visual state, and in a second opposite direction in the second visual state. As a result of the moving illumination, a user may more quickly and/or more reliably discern the direction of the airflow, and the direction in which to manipulate the haircare appliance.

1. A haircare appliance comprising a blower for generating an airflow, a plurality of outlets through which the airflow is discharged in one of a clockwise direction and a counterclockwise direction, and an indicator having a first visual state when the airflow is discharged in a clockwise direction and a second visual state when the airflow is discharged in a counterclockwise direction.

2. The haircare appliance as claimed in claim 1, wherein the appliance comprises a member moveable between a first position and a second position, the airflow is discharged in a clockwise direction when the member is in the first position, and the airflow is discharged in a counterclockwise direction when the member is in the second position.

3. The haircare appliance as claimed in claim 2, wherein the outlets comprise first outlets through which the airflow is discharged in a clockwise direction and second outlets through which the airflow is discharged in a counterclockwise direction, the member occludes the airflow to the second outlets when in the first position, and the member occludes the airflow to the first outlets when in the second position.

4. The haircare appliance as claimed in claim 2, wherein the appliance comprises a sensor for sensing the position of the member, and the indicator has a visual state that depends on an output of the sensor.

5. The haircare appliance as claimed in claim 2, wherein the appliance comprises a switch, movement of the member between the first position and the second position causes the switch to change from open to closed, the indicator has the first visual state when the switch is one of open and closed, and the visual indicator has the second visual state when the switch is the other of open and closed.

6. The haircare appliance as claimed in claim 2, wherein the appliance comprises a user-actuated selector for moving the member between the first position and the second position.

7. The haircare appliance as claimed in claim 6, wherein the selector comprises a dial that rotates to move the member between the first position and the second position.

8. The haircare appliance as claimed in claim 6, wherein the selector is provided at an end of the haircare appliance.

9. The haircare appliance as claimed in claim 1, wherein the indicator generates moving illumination in each of the first visual state and the second visual state, the movement occurring in a first direction in the first visual state and a second opposite direction in the second visual state.

10. The haircare appliance as claimed in claim 1, wherein the indicator comprises a ring of LEDs, and the LEDs are illuminated in a clockwise sequence in the first visual state and in a counterclockwise sequence in the second visual state.

11. The haircare appliance as claimed in claim 1, wherein the appliance comprises a handle unit and an attachment attached to the handle unit, the handle unit comprises the blower and the indicator, and the attachment comprises the outlets.

12. The haircare appliance as claimed in claim 11, wherein the attachment comprises a transmitter for transmitting wirelessly data to the handle unit, the handle unit comprises a receiver for receiving the data, and the indicator has a visual state that depends on the data.

13. The haircare appliance as claimed in 11, wherein the attachment comprises an RFID tag and the handle unit comprises an RFID reader, the RFID reader transmits an interrogation signal to the RFID tag, the RFID tag in response transmits data to the RFID reader, and the indicator has a visual state that depends on the data.

14. The haircare appliance as claimed in claim 13, wherein the RFID tag comprises an antenna and an integrated circuit, the antenna is provided at a first end of the attachment, and the integrated circuit is provided at a second opposite end of the attachment.

15. A handle unit of a haircare appliance, the handle unit being removably attachable to an attachment of the haircare appliance, wherein the handle unit comprises a blower for generating an airflow and an indicator, the attachment comprises a plurality of outlets through which the airflow is discharged in one of a clockwise direction and a counterclockwise direction, and the indicator has a first visual state when the airflow is discharged in a clockwise direction and a second visual state when the airflow is discharged in a counterclockwise direction.

16. An attachment of a haircare appliance, the attachment being removably attachable to a handle unit of the haircare appliance, wherein the attachment comprises an inlet for receiving an airflow from the handle unit, and a plurality of outlets through which the airflow is discharged in one of a clockwise direction and a counterclockwise direction, and the attachment provides an indication to the handle unit of the direction in which the airflow is discharged.
